(19) United States
(12) Patent Application Publication
(10) Pub. No.: US 2018/0095532 A1
(43) Pub. Date: Apr. 5, 2018

(54) Virtual Reality Head-Mounted Device

(71) Applicants: Yi-Chuan Cheng, Changhua County (TW); Kuo-Ching Chiang, New Taipei City (TW)

(72) Inventors: Yi-Chuan Cheng, Changhua County (TW); Kuo-Ching Chiang, New Taipei City (TW)

(21) Appl. No.: 15/356,545

(22) Filed: Nov. 19, 2016

(30) Foreign Application Priority Data
Oct. 4, 2016 (TW) 105132091
Oct. 26, 2016 (TW) 105134894

(51) Int. Cl. G06F 3/01; G06K 9/00; H04M 1/21

(52) U.S. Cl. CPC G06F 3/013; H04M 1/21; G06K 9/00617; G06K 9/00604

(57) ABSTRACT

The present invention provides a virtual reality display apparatus including a wireless transmitting module coupled to a control unit for receiving a virtual reality image sent by a cloud server, wherein the virtual reality display apparatus includes an eye control module and IRIS recognition module.

### CROSS-REFERENCE TO RELATED APPLICATIONS

This application is a Counter Part Application of TAIWAN Patent Application Ser. No. 105132091 and Ser. No. 105134894, which were filed on Oct. 4, 2016 and Oct. 26, 2016 respectively. The content of the above-mentioned patent applications are hereby incorporated by reference herein in their entirety and made a part of this specification.

### TECHNICAL FIELD

The present invention generally relates to a virtual reality device, in particular, to a virtual reality head-mounted device with eye control and iris recognition.

### DESCRIPTION OF RELATED ARTS

The virtual reality head-mounted device is popular and provides users with a spectacular sense of actually being there. The head-mounted device has eyepiece and headset, which are fixed on the head through the side and around the head strap, in order to provide realistic visual effects and experience of exploring the world. As viewing through the front plane screen in use of virtual reality, the head mounted device will display a small image in front of two eyes of each game player, the brain will combine the two images into three-dimensional experience. Because the lens will magnify the image, the image in front of the player is not a rectangular image different from that of watching TV screen. Television is usually showing 30 frame per second (FPS) and now some games are as high as 60 FPS. Virtual reality (VR) can display the image in 90 or 120 frame per second (FPS), which creates smooth and incomparable images to make the virtual world feel more real.

### SUMMARY

The purpose of the invention is to provides a virtual reality device or system. The invention provides an exercise machine system capable of displaying virtual reality image comprises an exercise device to provide for exercise of a user; a control device electrically coupled to the exercise (treadmill) device for controlling or detecting the exercise device; and a virtual reality display device having a first wireless module for wirelessly receiving a virtual reality image transmitted by a cloud server center, wherein the virtual reality display device plays the film of virtual reality according to the selection of the exerciser on the cloud server center. A virtual reality head-mounted device comprises an iris recognition light source; a sensor for receiving light emitted by the iris recognition light source and reflected by an iris; a memory for storing at least one iris template; and an iris recognition module for comparing an iris image received by the sensor with the at least one iris template, accessing based-on the comparison result. The iris recognition light source includes an infrared light source. The virtual reality head-mounted device further comprises a wireless transmitting module, coupled to a cloud server or a smart phone.

According to an aspect of the invention, a smart phone is for coupling to a virtual reality head-mounted device, the smart phone comprises an iris recognition light source; a sensor for receiving light emitted by the iris recognition light source and reflected by an iris; a memory for storing at least one iris template; and an iris recognition module for comparing an iris image received by the sensor with the at least one iris template, accessing based-on the comparison result. The iris recognition light source includes an infrared light source. The smart phone comprises a wireless transmitting module coupled to a cloud server.

According to another aspect of the invention, a virtual reality head-mounted device comprises a light source; a sensor for receiving light emitted by the light source and reflected by eyes; and an eye control module for controlling a virtual object based-on the received light and determined by a control unit. The light source includes an infrared light source. The virtual reality head-mounted device comprises a wireless transmitting module coupled to a cloud server or a smart phone. The virtual reality head-mounted device further comprises a sensor for receiving light emitted by the iris recognition light source and reflected by an iris; a memory for storing at least one iris template; and an iris recognition module for comparing an iris image received by the sensor with the at least one iris template, accessing based-on the comparison result.

The virtual reality image displays corresponding exercise parameters of an exercise device. The cloud server center includes a virtual reality generating module to provide a virtual reality image. The cloud server center includes virtual reality scene image of various classifications. The virtual reality image is uploaded by the user.

The virtual reality head-mounted device includes a processor, a wireless transmitting module and a display, wherein the wireless transmitting module and the display are coupled to the processor.

The wireless transmitting module is Bluetooth standard, Wi-Fi standard, 802.11x (x refers to a, b, g, n) standard compatible module, or WiMAX standard compatible module.

According to an aspect of the invention, an exercise system with virtual reality image by a cloud server comprises an exercise device to provide for exercise of a user; a control device electrically coupled to the exercise (treadmill) device for controlling or detecting the exercise device; and a virtual reality display device and a smart phone, having a first wireless module for wirelessly receiving a virtual reality image transmitted by a cloud server center, wherein the virtual reality display device plays the film of virtual reality according to the selection of the exerciser on the cloud server center. A virtual reality head-mounted device comprises an iris recognition light source; a sensor for receiving light emitted by the iris recognition light source and reflected by an iris; a memory for storing at least one iris template; and an iris recognition module for comparing an iris image received by the sensor with the at least one iris template, accessing based-on the comparison result. The iris recognition light source includes an infrared light source. The virtual reality head-mounted device further comprises a wireless transmitting module, coupled to a cloud server or a smart phone.

In another aspect, a virtual reality head-mounted device is wired or wirelessly coupled to a control device. The virtual reality head-mounted device includes a receiving module for wired or wirelessly receiving image data transmitted by a wireless communication module device, and the virtual reality head-mounted device or the wireless communication device has a virtual reality generating module. The wireless communication device is a smart phone.

These advantages and other advantages from the description of the following preferred embodiments and claims will enable persons skilled in the art to clearly understand the present invention.

### BRIEF DESCRIPTION OF THE DRAWINGS

The following diagrams are provided for detailed description and the embodiments of the invention such that the invention is fully understood; however, this can be only interpreted as a reference to understand the invention, rather than limit the invention in a particular embodiment.

FIG. 1 shows the functional diagram of a virtual reality head-mounted device of the present invention.

FIG. 2 shows the functional diagram of a virtual reality head-mounted device of the present invention.

FIG. 3 shows the functional diagram of a virtual reality head-mounted device and a cloud terminal of the present invention.

FIG. 4 shows the functional diagram of a virtual reality head-mounted device and a cloud terminal of the present invention.

FIG. 5 shows the functional diagram of a virtual reality head-mounted device and a cloud terminal of the present invention.

### DETAILED DESCRIPTION

Some preferred embodiments of the present invention will now be described in greater detail. However, it should be recognized that the preferred embodiments of the present invention are provided for illustration rather than limiting the present invention. In addition, the present invention can be practiced in a wide range of other embodiments besides those explicitly described, and the scope of the present invention is not expressly limited except as specified in the accompanying claims.

One embodiment of the specification refers to a particular description of the characteristic, method or property associated with this embodiment included in at least some embodiments. As a result, the implementation of an embodiment or some embodiments may not necessarily be the same. In addition, the associated characteristics, methods and properties of the invention may be appropriately combined with one or more embodiments.

It should be noted that, in order to give consideration to the effect of sports and entertainments, the invention provides a virtual reality apparatus or system. Virtual reality (also known as artificial environment) is using computer simulation to generate a virtual world in three dimensions to provide simulation of visual, auditory and tactile sense, let the user experiences an immersive environment and can timely observe things in three-dimensional space without limitation. When the user moves the position, the computer can be operated immediately, in order to return the accurate three-dimensional image of the world to experience the telepresence. Virtual reality technology is integrating computer graphics, computer simulation, artificial intelligence, sensing, display and network parallel processing technology, and is a kind of computer aided technology to produce an environmental simulation system.

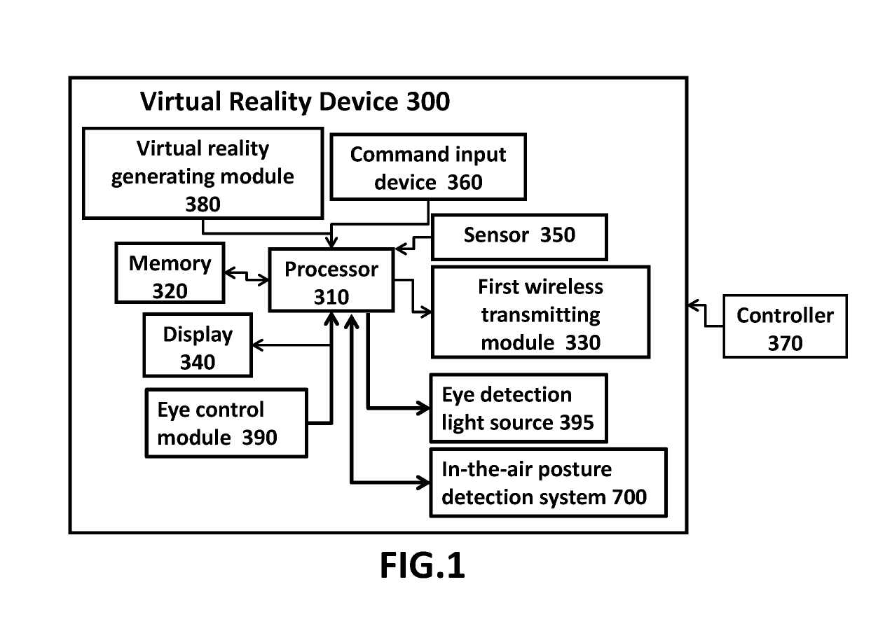

FIG. 1 is a functional diagram depicting a virtual reality head-mounted device 300 of an embodiment of the invention. In this embodiment, the virtual reality head-mounted device 300 includes a processor 310, a memory 320, a first wireless transmitting module 330, a display 340, a sensor 350, a command input device 360, a controller 370 and a virtual reality generating module 380, as shown in FIG. 1. The memory 320, the first wireless transmitting module 330, the display 340, the sensor 350, the command input device 360, the controller 370 and the virtual reality generating module 380 are coupled to the processor 310. In this embodiment, the virtual reality head-mounted device 300 generates a virtual reality video content by the virtual reality generating module 380. The virtual reality head-mounted device 300 is for example, a virtual reality helmet display or a virtual reality glasses display or a virtual reality stereo projector or a laser 3D stereo projector, etc. The users can operate the virtual reality head-mounted device 300 for displaying a virtual reality image. For example, the virtual reality display device 300 can receive a signal of an external direction controller 370, in order to control the direction of virtual reality image, and the menu by the command input device 360, in order to switch the frame or other selection function. Sensor 350 can be used to detect movement or shaking of the body, or shaking of the head, and so on. Sensor 350 is for example a region positioning sensor.

Please refer to FIG. 1, the virtual reality head-mounted device 300 comprises an eye detection light source (iris recognition light source) 395 to detect movement of eye, and the feedback signal of the detection is input to the processor 310 to determine the defined corresponding signal. Eye detection light source 395 can be an infrared light source. Accordingly, the processor 310 triggers the eye control module 390 to output a corresponding control signal. So, the control signal can be output by using the eye movement of a user. The virtual reality headset device 300 can generate a virtual environment. In some embodiments, the virtual reality head-mounted device 300 includes a helmet, visor, headband and eyepatch, in order to facilitate wearing the virtual reality head-mounted device 300 by the user. In some embodiments, for the electronic signal processing, the virtual reality head-mounted device 300 includes a processor 310, a memory 320, a wireless module 330 and a display 340. The memory 320 can store some commands, information, images, etc., which are used in the processor 310. The memory 320, the wireless module 330 and the display 340 are electrically coupled to the processor 310. The processor 310 of the virtual reality head-mounted device 300 is wired or wirelessly electrically coupled to the controller 370. In one embodiment, the controller 370 comprises a gravity sensor or an acceleration sensor in order to facilitate outputting a direction command to the processor 310. The controller 370 comprises a ring-shaped structure, which can be matched to user's finger or elbow, without grasping, for facilitating manipulation.

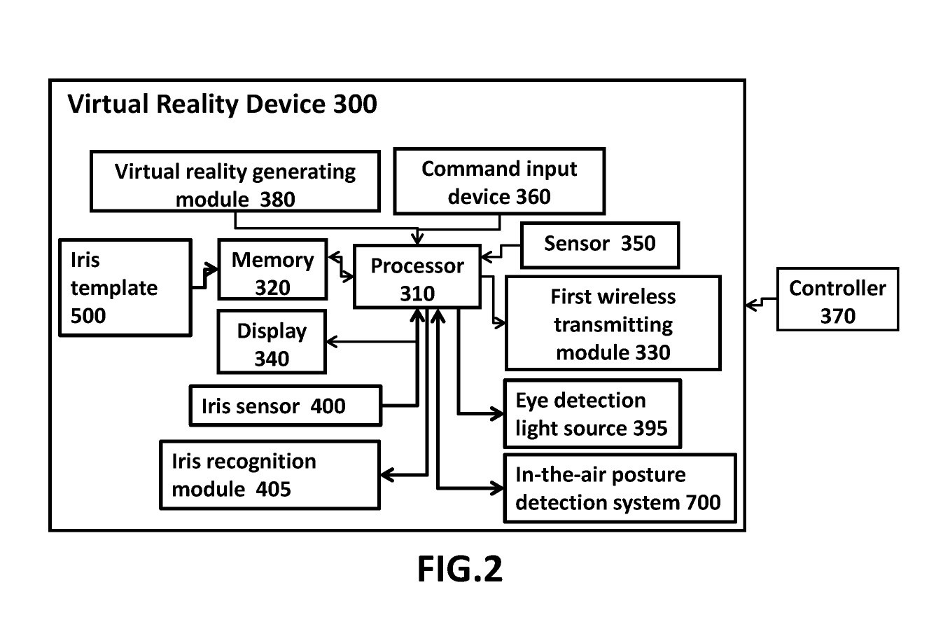

As shown in FIG. 2, it shows a functional diagram depicting a virtual reality head-mounted device of another embodiment of the invention. The scheme of this embodiment is similar to that of the FIG. 1, the virtual reality head-mounted device 300 includes an eye detection light source 395 for detecting iris, and the feedback signal of the detection is input to the processor 310; and an iris sensor 400 for receiving the feedback signal of the iris image, and then inputting to the iris recognition module 405, in order to facilitate identifying user identity. Subsequently, the command is triggered to determine whether the access is allowed or not based on the identification result. Therefore, the iris of the user can be as the security of control mechanism for the virtual reality head-mounted device 300 retrieving from or accessing into a system, a database, a remote server, a mobile phone or a tablet computer. At least one iris template 500 is stored in a memory, as the compared target of the user identification.

The controller 370 is provided with a control device, such as a power switch, a setting button, a liquid crystal display screen (touch screen), etc. The controller 370 can also be used for controlling for example the lateral inclination angle and the inclination speed, etc. through a wired or wireless control signal, and can detect the movement change by the sensor 350.

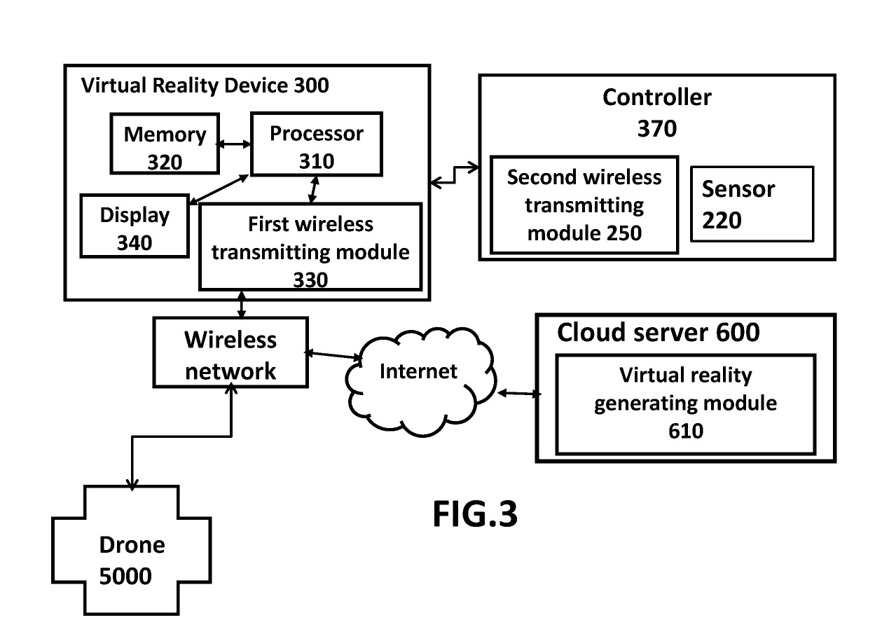

FIG. 3 shows the embodiment of the invention by utilizing an image capturing device to provide video data to a cloud server 600 and/or a virtual reality head-mounted device 300. In this embodiment, the virtual reality head-mounted device 300 is wired or wirelessly coupled to the controller 370, and the virtual reality head-mounted device 300 has a wireless transmitting module 250 for receiving or transmitting image data or commands by wired or wireless connection. The virtual reality head-mounted device 300 or the cloud server 600 has the virtual reality generating module.

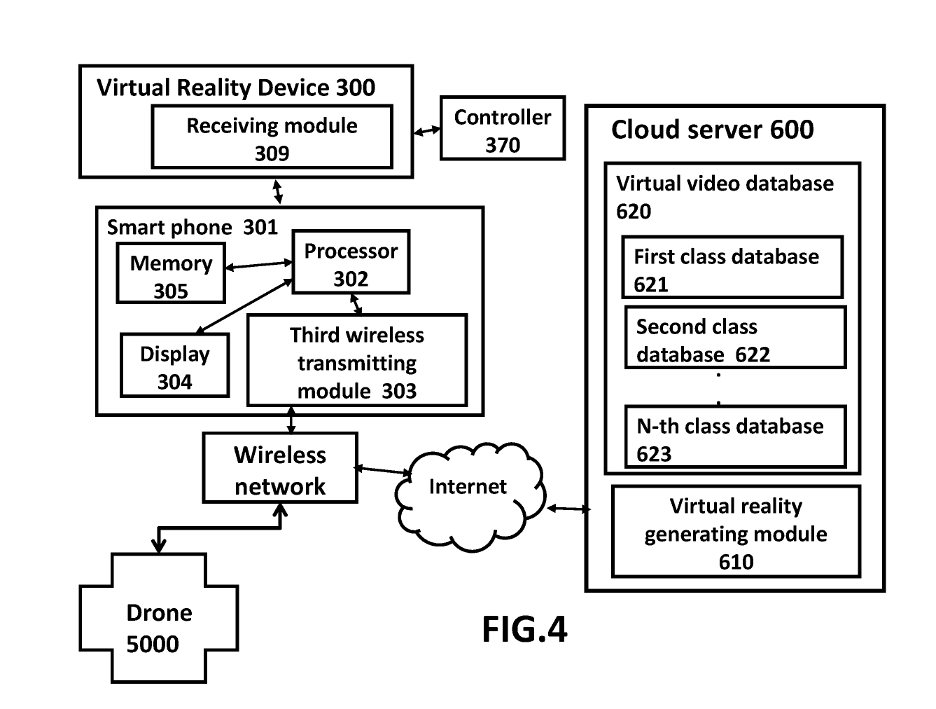

please refer to FIG. 4, a wireless communications device 301, such as smart phones, includes a processor 302, a memory 305, a third wireless transmitting module 303 and a display 304. In this embodiment, the smart phone 301 provides a video or image data to the cloud server 600, and downloads streaming data to the virtual reality display device 300 by the third wireless transmitting module 30. The streaming data downloaded from the smart phone 301 is processed by the virtual reality generating module 380 of the virtual reality display device 300 to produce a video content of virtual reality. In another example, the streaming data downloaded from the smart phone 301 is processed by itself embedded virtual reality generating module to create a video content of virtual reality to be displayed by the display 304. An image acquiring device, such as a portable camera, wearable camera or smart phone, is shooting the image and then uploading the video or image data (such as the shot reality film) to the cloud server center 600 by computer, laptop, tablet computer or smart phone 301. Therefore, the cloud server center 600 includes many of image or video data acquired by the image acquiring device or users a large number of image or video data transmitted by the smart phone 301. These image or video data (films) are processed to generate image or video content of virtual reality by the virtual reality generating module 610 and stored in a virtual video database 620. According to different attributes or categories for classification, these contents will be stored in a variety of categories of the database including first class database 621, second class database 622, . . . and N-th class database 623 respectively. Therefore, the user of the virtual reality display device 300 can choose any class of the virtual video database 620 as a virtual reality image/video for viewing.

The virtual reality display device 300 can be combined with the smart phone 301. Based-on the virtual reality display device 300 with a sensor 350 and a controller 370, the smart phone 301 provides real-time games to virtual reality display device 300 to provide for playing virtual reality game when a user exercises. Therefore, the user wearing the virtual reality display device 300 can play online games for fun by the virtual reality display device 300 wirelessly coupled to the smart phone 301 or by a network (on-line) game server. In one embodiment, the virtual reality display device 300 comprises a vibration feedback unit to reflect the vibration of the game scene to increase telepresence in the game. In another embodiment, the virtual reality head-mounted device 300 includes an in-the-air gesture detection systems 700 to detect the user's posture.

In one embodiment, the virtual reality display device 300 is combined with the smart phone with 301 by Micro USB, and the smart phone 301 is directly supplied power to the virtual reality display device 300. Therefore, an exercise machine system of the invention can be combined with the smart phone to make a user of the exercise machine experience virtual reality. The eye detection light source 395 and the iris sensor 400 can be configured into (onto) the smart phone. In addition, the eye detection light source 395 and the eye control module 390 can be configured into (onto) the smart phone. In another embodiment, the first embodiment of FIG. 1 integrates with the second embodiment of FIG. 2 so that the system has the function of iris recognition and the function of eye control command.

In an embodiment, a virtual reality head-mounted device 300 may be put on the head, and the processor 310 executes commands to implement generation of the virtual reality image. The processor 310 can be a general purpose processor, a system on chip (SOC) processor, an application-specific integrated circuit (ASIC) or other similar processor configuration. A pair of display 340 can be configured on corresponding two eyes of the user. In one embodiment, each display 340 can include a liquid crystal display, OLED display or other similar display, used to display virtual reality image. In another embodiment, each display may include a transparent liquid crystal display, a transparent organic light emitting diode display or other similar display, whereby images in the real world and the virtual reality image displayed on the display can be viewed directly to maintain the ability of viewing the real world's environment through the display. In addition, the virtual reality head-mounted device 300 includes an eye tracker (eye-gaze tracking), or contains at least one camera device. The camera device 350, the memory 320, the eye-gaze tracking and the display 340 are electrically coupled to the processor 310.

The virtual reality head-mounted device 300 has a wireless transmitting module coupled to the virtual reality generating module 610 of a cloud server center 600, such as graphics generation system, through a wireless network and an Internet. The wireless transmitting module is, for example a wireless local area network communication module (WLAN module) or a WiFi module for transmitting data. The camera 350 can capture real-time images outside of the virtual reality head-mounted device 300. The captured images can be transmitted to the virtual reality generating module 610 of the cloud server center 600, and image/video content of virtual reality is then generated by the virtual reality generating module 610. The image/video content of virtual reality is transmitted to virtual reality head-mounted device 300 and then displays the image/video content of virtual reality by the display 340.

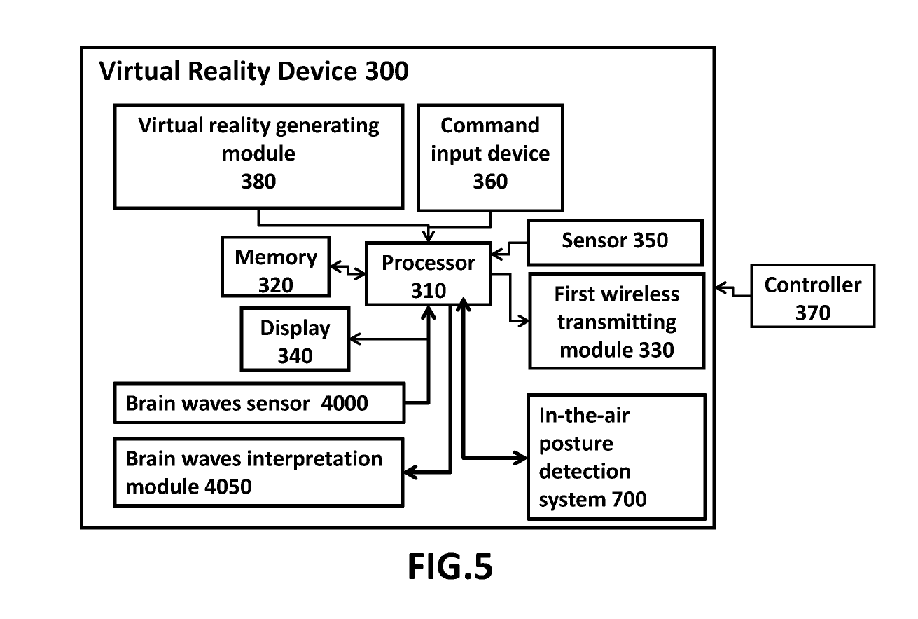

A command, cursor, item or function of a user device (such as virtual reality head mounted device 300) can be controlled by activity of the user, for example by measuring brain activity. Electroencephalography (EEG) is an electrophysiological monitoring method to record electrical activity of the brain, which can be attached to multiple electrode placed on the scalp for measuring. Electroencephalogram (EEG) signals is derived from the cerebral cortex, which is a layer of highly spiral neuronal tissue with several centimeters thick. If the user focus on simple mental isolation action such as closed eyes, the brain may produce Alpha wave (8-13 Hz). Beta wave (14-30 Hz) is concerned with the mental state of vigilance. Theta wave (4-7 Hz) is usually associated with the early stage of sleep, frustration or disappointment. Dell wave (below 3.5 Hz) is related to the deep sleep. Electromyography (EMG) sensors can be attached to the human body skin to sense and translate muscle response. In addition, electrooculography (EOG) signal can be detected from the eye movement. FIG. 5 is schematic diagram of an embodiment of the invention. Neural activity is tracked by the neural activity detection device. The tracked neural activity is preferably including electroencephalogram (EEG), electrooculography (EOG) and electromyographic (EMG) activity. An electronic signal that represents a neural activity is transmitted to the control unit via a wired or wireless connection. If the predetermined signal is sensed by the detection device, which can monitor the same electroencephalogram (EEG) readings. For example, if a user focuses on some actions, an Alpha wave (8-13 Hz) can be generated. Therefore, if the focus mode is detected, the system responds to the above signal and sends out a command to perform the preset function. It should be noted that status mode of the potential user can be monitored before the system is used. Many elements of this embodiment are similar to the previous embodiment, and the detailed descriptions are omitted. The present embodiment comprises a brain waves sensor 4000, and a brain waves interpretation module 4050. The processor 310 is coupled to the brain waves sensor 4000 and the brain waves interpretation module 4050, which uses a wireless or wired connection to receive the neural signal sensed by the brain waves sensor 4000, and using the brain waves interpretation module 4005 for analyzing neural electronic signal. The operating system is operated by the processor to control the components and coordinate application software and programs of the system to further control the function module. The programs contain a program for converting the received neural electronic signals into an indicator or action on the display screen. Utilizing the above device, the user can control an action of the user device by the brain waves sensor 4000 inputting neural information to the system of the invention. According to the program of the invention, it allows the user use the sensed neural signal to control the user device, and a procedure (program) may provide a level (or mode) of neural activity for predetermining user attention degree. A brain wave sensor 4000 is provided for monitoring neural activity of the user, to decide when to reach the predetermined level of neural activity. Therefore, brain wave (EEG) mode of the user is made. The neural activity of the user is converted into an electronic signal so as to give the command for executing software function. Similarly, if using electromyography (EMG) sensor and the brain wave interpretation module 4005, then the electromyography (EMG) sensors can be attached to the skin, to sense and translate the muscle impulse, and then output command by the electromyography (EMG). In addition, it can also use the electrooculography (EOG) sensor and electromyographic (EMG) interpretation module. The embodiments of the above figures can be used alone or in combination, depending on the requirements.

In one embodiment, true image, virtual image or the identification name of the user of the virtual reality display device 300 may be displayed on the display 340 together with the image content of virtual reality, also can be displayed on the image content of virtual reality, let the user know that the other game player is joined in the image content of virtual reality, and therefore each of the players may watch and share the identical image content of virtual reality. In order to achieve the above purposes, the user login the server agrees with the information spread and displayed on the virtual reality display of others.

In one embodiment, the memory includes read-only memory (ROM), random access memory (RAM) or nonvolatile flash memory.

The above wireless local area network communication module (WLAN module) is compatible with and can deal with the data transmission of the wireless local area network protocol. For example, the wireless LAN communication module is a Bluetooth compatible module, a Wi-Fi compatible module, 802.11x compatible module, NFC (Near Field Communication) module, or WiMAX (Worldwide Interoperability for Microwave Access) compatible module. The virtual reality display device 300 of the invention can receive video content of virtual reality (for example: image or video content recorded by wearable recorder, digital video recorder, such as tourist attractions, historic monuments, street scenery, natural scenery . . . and so on) generated by the virtual reality generating module 610 of the cloud server center 600 by the wireless local area network communication module. In addition, the virtual reality display device 300 can wirelessly receive the signal transmitted by a drone 5000. The drone 5000 has at least two cameras to facilitate creating virtual reality image, and the virtual reality display device 300 can transmit a control command to the drone 5000 through the wireless transmitting module, shown in FIG. 3 and FIG. 4. In this embodiment, the virtual reality display device 300 has control program (module) of drone stored in memory 320, in order to control the drone 5000. The control program (module) of drone can be downloaded from the cloud terminal or remote server 600.

When a user wears a virtual reality helmet display on his head, the display can display various environment simulation film to create 3D stereo interactive effect. Therefore, the user can feel the real sense and telepresence fun of exercising in a variety of environments with effects of both entertainment and sports as the user puts on the virtual reality helmet display.

It will be understood that the above descriptions of embodiments are given by way of example only and that various modifications may be made by those with ordinary skill in the art. The above specification, examples and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of this invention.

What is claimed is:

1. A virtual reality head-mounted device, comprising:
an iris recognition light source;
a sensor for receiving light emitted by said iris recognition light source and reflected by an iris;
a memory for storing at least one iris template; and
an iris recognition module for comparing an iris image received by said sensor with said at least one iris template.

2. The device as set forth in claim 1, wherein said iris recognition light source includes an infrared light source.

3. The device as set forth in claim 1, further comprising a wireless transmitting module.

4. The device as set forth in claim 3, wherein said wireless transmitting module is coupled to a cloud server.

5. The device as set forth in claim 3, wherein said wireless transmitting module is coupled to a smart phone.

6. The device as set forth in claim 3, wherein said wireless transmitting module is Bluetooth standard, Wi-Fi standard, or 802.11x (x refers to a, b, g, n) standard compatible module.

7. A smart phone for coupling to a virtual reality head-mounted device, comprising:
an iris recognition light source;
a sensor for receiving light emitted by said iris recognition light source and reflected by an iris;
a memory for storing at least one iris template; and
an iris recognition module for comparing an iris image received by said sensor with said at least one iris template.

8. The smart phone as set forth in claim 7, wherein said iris recognition light source includes an infrared light source.

9. The smart phone as set forth in claim 7, further comprising a wireless transmitting module.

10. The smart phone as set forth in claim 9, wherein said wireless transmitting module is Bluetooth standard, Wi-Fi standard, or 802.11x (x refers to a, b, g, n) standard compatible module.

11. The smart phone as set forth in claim 9, wherein said wireless transmitting module is coupled to a cloud server.

12. The smart phone as set forth in claim 9, wherein said wireless transmitting module is coupled to said virtual reality head-mounted device.

13. A virtual reality head-mounted device, comprising:
a light source;
a sensor for receiving light emitted by said light source and reflected by eyes; and
an eye control module for controlling a virtual object based-on said received light and determined by a control unit.

14. The device as set forth in claim 13, wherein said light source includes an infrared light source.

15. The device as set forth in claim 13, further comprising a wireless transmitting module.

16. The device as set forth in claim 15, wherein said wireless transmitting module is Bluetooth standard, Wi-Fi standard, or 802.11x (x refers to a, b, g, n) standard compatible module.

17. The device as set forth in claim 15, wherein said wireless transmitting module is coupled to a cloud server.

18. The device as set forth in claim 13, wherein said wireless transmitting module is coupled to a smart phone.

19. The device as set forth in claim 13, further comprising
a sensor for receiving light emitted by said light source and reflected by an iris;
a memory for storing at least one iris template; and
an iris recognition module for comparing an iris image received by said sensor with said at least one iris template.
a sensor for receiving light emitted by said iris recognition light source and reflected by an iris;
a memory for storing at least one iris template; and
an iris recognition module for comparing an iris image received by said sensor with said at least one iris template.

20. The device as set forth in claim 19, wherein said sensor includes a region positioning sensor.
